(19) United States
(12) Patent Application Publication
(10) Pub. No.: US 2022/0234614 A1
(43) Pub. Date: Jul. 28, 2022

(54) SAMPLING-BASED MANEUVER REALIZER

(71) Applicant: Motional AD LLC, Boston, MA (US)

(72) Inventors: Emilio Frazzoli, Newton, MA (US); Juraj Kabzan, Singapore (SG)

(21) Appl. No.: 17/544,678

(22) Filed: Dec. 7, 2021

Related U.S. Application Data
(60) Provisional application No. 63/142,871, filed on Jan. 28, 2021.

(51) Int. Cl. B60W 60/00; B60W 30/14; G06F 17/17

(52) U.S. Cl. CPC B60W 60/0011; B60W 60/0013; B60W 2520/10; G06F 17/17; B60W 30/143

(57) ABSTRACT

Enclosed are embodiments for a sampling-based maneuver realizer. In an embodiment, a method comprises: obtaining, using at least one processor, a maneuver description for a vehicle, the maneuver description describing a union of dynamic station-time constraints and station-spatial-time constraints on the vehicle, wherein the dynamic station-time constraints are parameterized in time and the dynamic station-spatial-time constraints are parameterized in station and time; sampling, using the at least one processor, the dynamic station-time constraints and dynamic station-spatial-time constraints; solving, using the at least one processor, an optimization problem using a cost function of the sampled dynamic station-time constraints, the sampled dynamic station-spatial-time constraints and a motion model; and generating, using the at least one processor, a trajectory based on the solved optimization problem, wherein the trajectory fulfills the dynamic station-time constraints and the dynamic station-spatial-time constraints imposed by the maneuver description.

### RELATED APPLICATION

This application claims the benefit of U.S. Provisional Application Ser. No. 63/142,871, filed Jan. 28, 2021, the entire contents of which are incorporated herein by reference.

### FIELD OF THE INVENTION

The description that follows relates to route planners for autonomous vehicles.

### BACKGROUND

Autonomous vehicles use a route planner in their software stacks to generate candidate trajectories for the autonomous vehicle under various scenarios. The planner uses sensor data and the vehicle's physical state (e.g., position, speed, heading) to generate possible trajectories for the vehicle to avoid collision with agents (e.g., other vehicles, pedestrians) in the vicinity of the autonomous vehicle. The planner typically takes into consideration the violation of traffic laws and possibly other driving rules (e.g., safety, ethics, local culture, passenger comfort, courtesy, performance, etc.) when determining which candidate trajectory the vehicle should take for a given scenario. Accordingly, it is desirable to evaluate planned trajectories under a large variety of scenarios that may occur in the real-world.

### SUMMARY

Techniques are provided for a sampling-based maneuver realizer.

In an embodiment, a method comprises: obtaining, using at least one processor, a maneuver description for a vehicle, the maneuver description describing a union of dynamic station-time constraints and station-spatial-time constraints on the vehicle, wherein the dynamic station-time constraints are parameterized in time and the dynamic station-spatial-time constraints are parameterized in station and time; sampling, using the at least one processor, the dynamic station-time constraints and dynamic station-spatial-time constraints; solving, using the at least one processor, an optimization problem using a cost function of the sampled dynamic station-time constraints, the sampled dynamic station-spatial-time constraints and a motion model; and generating, using the at least one processor, a trajectory based on the solved optimization problem, wherein the trajectory fulfills the dynamic station-time constraints and the dynamic station-spatial-time constraints imposed by the maneuver description.

In an embodiment, the dynamic station-spatial-time constraints contain biasing decisions explicitly.

In an embodiment, the motion model is a kinematic bicycle model.

In an embodiment, the solving is continuous and iterative.

In an embodiment, the continuous and iterative solving converges when the optimized trajectory satisfies the dynamic station-time and station-spatial-time constraints without sampling.

In an embodiment, the trajectory maximizes comfort constraints imposed on the vehicle.

In an embodiment, the method further comprises: solving, using the at least one processor, a longitudinal speed optimization problem to determine where to start sampling the dynamic station-time and dynamic station-spatial-time constraints.

In an embodiment, the longitudinal speed optimization problem includes static speed profile constraints and maneuver station-time constraints.

In an embodiment, the static speed profile constraints limit maximal lateral acceleration of the vehicle by considering path curvature.

In an embodiment, the solving the longitudinal speed opination problem provides an initial guess of acceleration and velocity for solving the optimization problem.

In an embodiment, the method further comprises: initiating, using a control circuit, a maneuver by the vehicle based on the trajectory.

In an embodiment, a non-transitory, computer-readable storage medium having stored thereon instructions, that when executed by at least one processor, causes the at least one processor to perform the methods recited above.

In an embodiment, a vehicle comprises: at least one processor; a non-transitory, computer-readable storage medium having stored thereon instructions, that when executed by the at least one processor, causes the at least one processor to perform the methods recited above.

One or more of the disclosed embodiments provide one or more of the following advantages. The sampling-based maneuver realizer generates a trajectory that fulfills the dynamic station-time and station-spatial-time constraints imposed by a homotopy and at the same time maximizes passenger comfort. The trajectory is generated by solving an optimization problem using a cost function on dynamic station-time and station-spatial-time constraints, a motion model and passenger comfort constraints. Biasing decisions are carried out in the dynamic station-spatial-time constraints even if agents are beyond the predicted horizon. Station-time constraints are parameterized by time for which corresponding timesteps of a continuous and iterative optimization can be used without any loss of information, i.e., no approximations. For well-posed problems, a single iteration of the optimization may be sufficient to generate a trajectory that fulfills the dynamic station-time and station-spatial-time constraints imposed by the homotopy and passenger comfort constraints.

Imposing station and spatial constraints on top of each other results in a full maneuver description that can be continuously sampled along its defined time horizon, which greatly streamlines the architecture of planning system. There is no need for further decisions, and proximity constraints are directly represented as a continuous function which can be used for optimization.

These and other aspects, features, and implementations can be expressed as methods, apparatus, systems, components, program products, means or steps for performing a function, and in other ways. These and other aspects, features, and implementations will become apparent from the following descriptions, including the claims.

### BRIEF DESCRIPTION OF THE DRAWINGS

FIG. 1 shows an example of an autonomous vehicle (AV) having autonomous capability, in accordance with one or more embodiments.

FIG. 2 illustrates an example “cloud” computing environment, in accordance with one or more embodiments.

FIG. 3 illustrates a computer system, in accordance with one or more embodiments.

FIG. 4 shows an example architecture for an AV, in accordance with one or more embodiments.

FIG. 5 is a block diagram of a route planning system, in accordance with one or more embodiments.

FIG. 6 illustrates example homotopy for a driving scenario where a vehicle must change lanes due to an obstacle in its path, in accordance with one or more embodiments.

FIGS. 7A and 7B illustrate a maneuver description and spatial constraints, respectively, in accordance with one or more embodiments.

FIG. 8 illustrates an example model predictive controller (MPC)-like formulation for a collision avoidance maneuver, in accordance with one or more embodiments.

FIG. 9 illustrates sampling station-time constraints, in accordance with one or more embodiments.

FIG. 10 illustrates sampling spatial-station-time constraints, in accordance with one or more embodiments.

FIG. 11 illustrates an example longitudinal realization, in accordance with one or more embodiments.

FIG. 12A is an example maneuver description for an example driving scenario involving two agents, in accordance with one or more embodiments.

FIG. 12B illustrates acceleration and velocity profiles for the example driving scenario, in accordance with one or more embodiments.

FIG. 12C is a bird's eye view (BEV) of the example driving scenario, in accordance with one or more embodiments.

FIG. 13 is a flow diagram of process for sampling dynamic station-time and station-spatial-time constraints, in accordance with one or more embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. General Overview

2. System Overview

3. Autonomous Vehicle Architecture

4. Sample-Based Maneuver Realizer

### General Overview

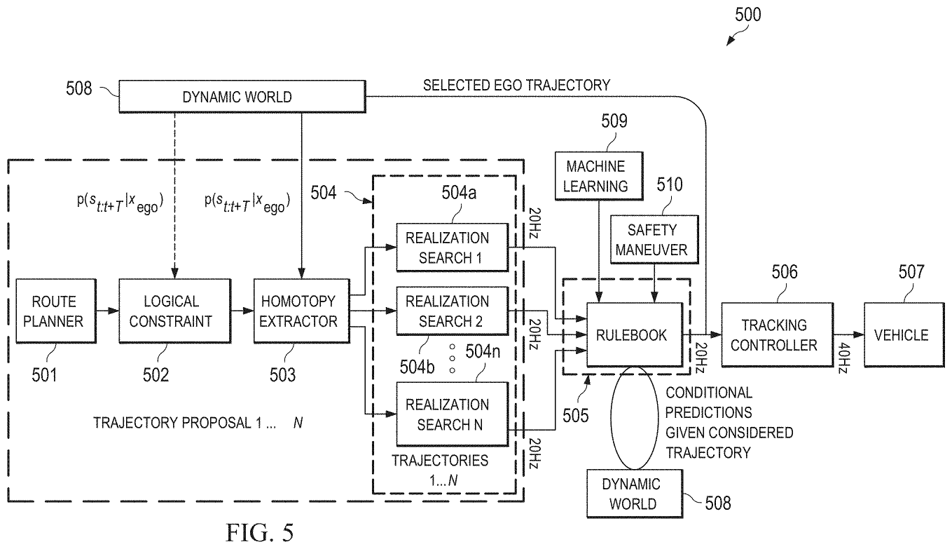

Techniques are provided for a sampling-based maneuver realizer. The sampling-based maneuver realizer can be part of a route planning system architecture for autonomous vehicles, as shown in FIG. 5. Given a maneuver description, the maneuver realizer computes in real-time one or more realizations (e.g., hereinafter also referred to as “trajectories”) of the AV based on the AV's capabilities and AV motion constraints. The output of the realizer is a continuous trajectory which represents how the AV will move in the near future (e.g., next 10 ms). In an embodiment, a maneuver is described as a union of station-time (e.g., drivable area) and station-spatial-time constraints (e.g., longitudinal and lateral clearance).

Given a motion model (e.g., a kinematic bicycle model), dynamic station-time constraints and station-spatial-time constraints and an objective function, the realizer iteratively and continuously solves a initialization-dependent optimization problem on the motion model and constraints. Since the optimization is directly discretized in time, the optimization allows for sampling of station-time constraints without loss of information, i.e., no approximations.

In an embodiment, the station-spatial-time constraints are parameterized by two variables: station along a baseline trajectory and time. Because at the first iteration of the optimization, it is not known where to sample station points, a fast initialization-independent point mass longitudinal speed optimization problem is solved first, which includes profile constraints for passenger comfort and homotopy station-time constraints (hereinafter, also referred to as “initial optimization”). In addition to a sampling approximation, an initial guess for the optimization solver is also computed.

After the initial optimization, the iterative optimization is solved using the initial guess from the initial optimization, and includes station constraints, spatial constraints, the motion model and comfort objectives (e.g., acceleration/decelerating and speed maximums). In an embodiment, the iterative optimization converges when the resulting trajectory satisfies all specified constraints without sampling. Due to the initial optimization, a single iteration of the optimization may be sufficient to generate a trajectory that fulfills the constraints imposed by the maneuver description and comfort constraints for well-posed problems.

Using the foregoing optimizations, multiple AV trajectories are computed which fulfill the dynamics and physical constraints of the AV. The trajectories can be provided to a trajectory score generator that uses one or more rulebooks, one or more machine learning models and/or one or more safety maneuver models to evaluate (e.g., score) the trajectories, and then uses the results of the evaluating to select a trajectory that is the most compliant with the rules in the one or more rulebooks.

The selected trajectory is parameterized in time and input into a tracking controller that implements an MPC-like formulation with constraints on the control inputs and states that allows the tracking controller to query an exact desired position of the AV at a given time.

### System Overview

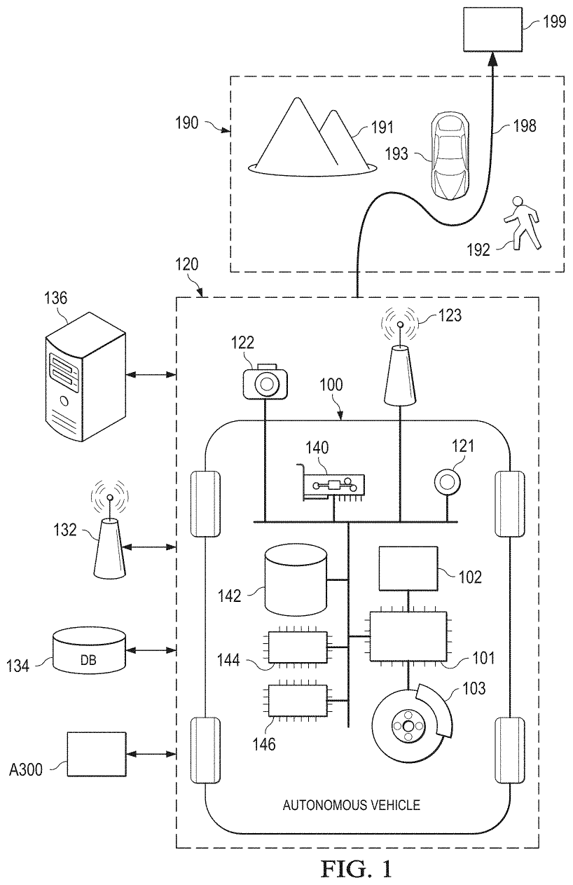

FIG. 1 shows an example of an autonomous vehicle 100 having autonomous capability.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, motorcycles, bicycles, etc. A driverless car is an example of a vehicle.

As used herein, “trajectory” refers to a path or route to operate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “realization” refers to a trajectory generated by the sample-based maneuver realizer, described herein.

A “maneuver” is a change in position, speed or steering angle (heading) of an AV. All maneuvers are trajectories but not all trajectories are maneuvers. E.g., an AV trajectory where the AV is traveling in a straight path at a constant speed is not a maneuver.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle and may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings or having two lanes between the lane markings. A lane could also be interpreted in the absence of lane markings. For example, a lane may be defined based on physical features of an environment, e.g., rocks and trees along a thoroughfare in a rural area.

As used herein, a “rulebook” is a data structure implementing a priority structure on a set of rules that are arranged based on their relative importance, where for any particular rule in the priority structure, the rule(s) having lower priority in the structure than the particular rule in the priority structure have lower importance than the particular rule. Possible priority structures include but are not limited to: hierarchical structures (e.g., total order or partial-order on the rules), non-hierarchical structures (e.g., a weighting system on the rules) or a hybrid priority structure in which subsets of rules are hierarchical but rules within each subset are non-hierarchical. Rules can include traffic laws, safety rules, ethical rules, local culture rules, passenger comfort rules and any other rules that could be used to evaluate a trajectory of a vehicle provided by any source (e.g., humans, text, regulations, websites).

As used herein, “ego vehicle” or “ego” refers to a virtual vehicle or AV with virtual sensors for sensing a virtual environment that is utilized by, for example, a planner to plan the route of the virtual AV in the virtual environment.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “includes,” and/or “including,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

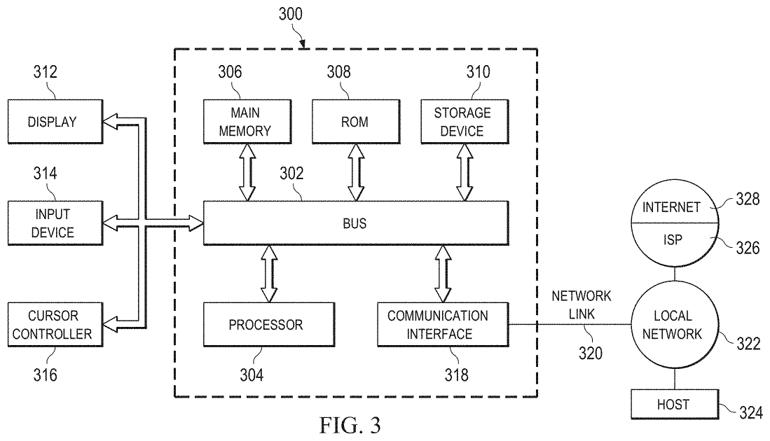

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 300 described below with respect to FIG. 3.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Referring to FIG. 1, an AV system 120 operates the AV 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In an embodiment, the AV system 120 includes devices 101 that are instrumented to receive and act on operational commands from the computer processors 146. In an embodiment, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the AV 100, such as the AV's position, linear velocity and acceleration, angular velocity and acceleration, and heading (e.g., an orientation of the leading end of AV 100). Example of sensors 121 are a Global Navigation Satellite System (GNSS) receiver, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the AV 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the AV 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among autonomous vehicles.

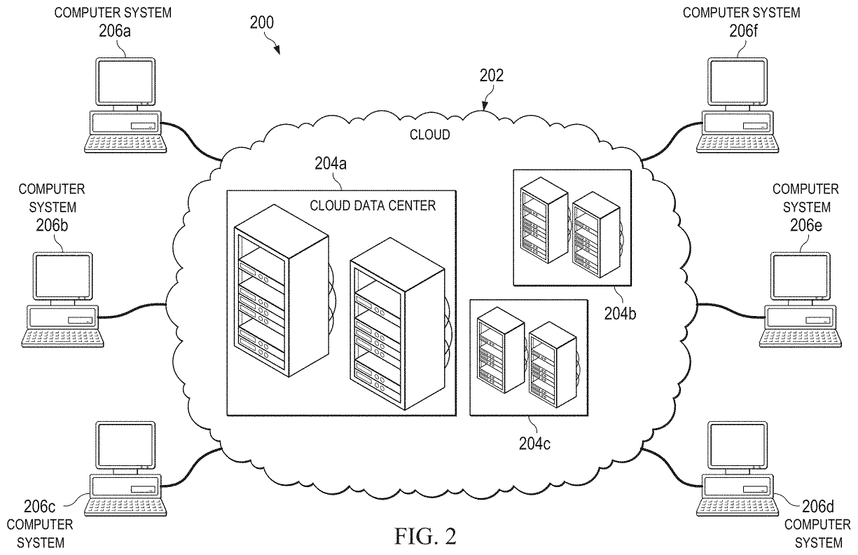

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication interfaces 140 transmit data collected from sensors 121 or other data related to the operation of AV 100 to the remotely located database 134. In an embodiment, communication interfaces 140 transmit information that relates to teleoperations to the AV 100. In some embodiments, the AV 100 communicates with other remote (e.g., “cloud) servers 136.

In an embodiment, the remotely located database 134 also stores and transmits digital data (e.g., storing data such as road and street locations). Such data is stored on the memory 144 on the AV 100, or transmitted to the AV 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data may be stored on the memory 144 on the AV 100, or transmitted to the AV 100 via a communications channel from the remotely located database 134.

Computing devices 146 located on the AV 100 algorithmically generate control actions based on both real-time sensor data and prior information, allowing the AV system 120 to execute its autonomous driving capabilities.

In an embodiment, the AV system 120 includes computer peripherals 132 coupled to computing devices 146 for providing information and alerts to, and receiving input from, a user (e.g., an occupant or a remote user) of the AV 100. In an embodiment, peripherals 132 are similar to the display 312, input device 314, and cursor controller 316 discussed below in reference to FIG. 3. The coupling is wireless or wired. Any two or more of the interface devices may be integrated into a single device.

### Example Cloud Computing Environment

FIG. 2 illustrates an example “cloud” computing environment. Cloud computing is a model of service delivery for enabling convenient, on-demand network access to a shared pool of configurable computing resources (e.g., networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, autonomous vehicles (including, cars, drones, shuttles, trains, buses, etc.) and consumer electronics. In an embodiment, the computing systems 206a-f are implemented in or as a part of other systems.

### Computer System

FIG. 3 illustrates a computer system 300. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 300 includes a bus 302 or other communication mechanism for communicating information, and a hardware processor 304 coupled with a bus 302 for processing information. The hardware processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that include the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 may optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic, or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

### Autonomous Vehicle Architecture

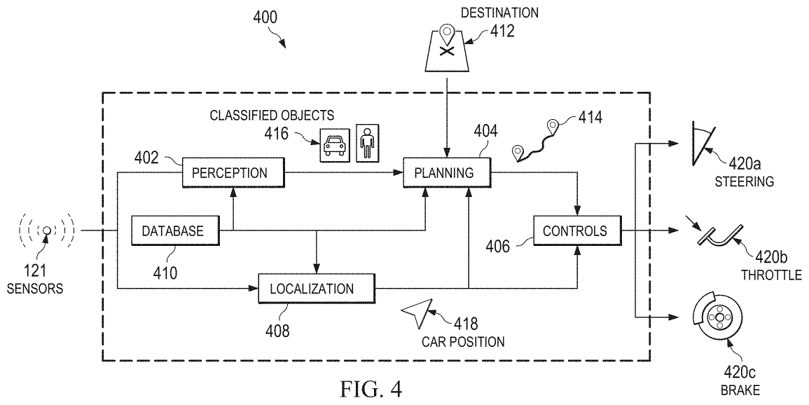

FIG. 4 shows an example architecture 400 for an autonomous vehicle (e.g., the AV 100 shown in FIG. 1). The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the AV 100. Together, the modules 402, 404, 406, 408, and 410 may be part of the AV system 120 shown in FIG. 1. In some embodiments, any of the modules 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things).

In use, the planning module 404 receives data representing a destination 412 and determines data representing a trajectory 414 (sometimes referred to as a route) that can be traveled by the AV 100 to reach (e.g., arrive at) the destination 412. In order for the planning module 404 to determine the data representing the trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a GNSS receiver and geographic data to calculate a longitude and latitude of the AV. In an embodiment, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types.

The control module 406 receives the data representing the trajectory 414 and the data representing the AV position 418 and operates the control functions 420a-c (e.g., steering, throttling, braking, ignition) of the AV in a manner that will cause the AV 100 to travel the trajectory 414 to the destination 412. For example, if the trajectory 414 includes a left turn, the control module 406 will operate the control functions 420a-c in a manner such that the steering angle of the steering function will cause the AV 100 to turn left and the throttling and braking will cause the AV 100 to pause and wait for passing pedestrians or vehicles before the turn is made.

In an embodiment, any of the foregoing modules 402, 404, 406, 408 can send a request to a rule-based trajectory validation system 500 to validate a planned trajectory and receive a score for the trajectory, as described in further detail in reference to FIGS. 5-18.

### Sample-Based Maneuver Realizer

FIG. 5 is a block diagram of a planning system 500, in accordance with one or more embodiments. System 500 includes route planner 501, logical constraint generator 502, homotopy extractor 503, sample-based maneuver realizer 504, trajectory score generator 505, tracking controller 506 and AV 507.

In an embodiment, the route planner 501: 1) receives an initial and terminal state for AV 507; 2) plans a desired sequence of geometric blocks of road data (“roadblocks”) forming lanes with a lane router; 3) divides the route into road segments based on a lane change, such that a segment does not contain a lane change; 4) selects road segments in which the AV 507 is located based on the AV's physical state (obtained from dynamic world model 508) which is projected on the roadblocks; 5) extracts anchor paths for selected road segments (which can be marked as anchor “desired” in case a lane change is desired); and 6) trims anchor paths based on maximal/minimal length. In case there is no lane change required, the adjacent anchor path is extracted and labeled only as “optional,” meaning the AV 507 can use the lane if needed for collision avoidance.

In an embodiment, route planner 501 generates a graphical representation of the operating environment of AV 507, the physical state of AV 507 based on sensor data (e.g., speed, position) and possible outcomes. In an embodiment, the graphical representation is a decision graph that includes a number of nodes where each node represents a sample of the decision space for a particular driving scenario for AV 507, such as, for example, a plurality of maneuvers related to other vehicles and objects and environmental constraints (e.g., drivable area, lane markings). The edges of the decision graph represent different trajectories available to AV 507 for the particular driving scenario.

In an embodiment, logical constraint generator 502 includes generating at least one of “hard” constraints or “soft” constraints. Hard constraints are logical constraints that must not be violated because, if violated, the AV would collide with another object, such as a pedestrian who maybe “jaywalking” across the road. Note that hard constraints do not imply “do not collide.” Rather, a hard constraint can be, for example, a combination of spatial and speed constraints that can lead to a collision. For example, a hard constraint can be expressed in words as: “if the AV proceeds at 30 mph in lane A or accelerates at 2 mph/s in lane B, it will collide with the pedestrian.” Hence, the hard constraint expressed formally is “do not proceed at 30 mph in lane A” and “do not exceed 25 mph in lane A.”

Soft constraints are constraints that should be followed by the AV but can be violated to, for example, complete a trip to a destination or to avoid a collision. Some examples of “soft” constraints include but are not limited to: passenger comfort constraints and a minimum threshold of lateral clearance from a pedestrian who is crossing the street (“jaywalking”) to ensure that the pedestrian and the AV passenger are comfortable with the AV's maneuvering. In an embodiment, soft constraints can be embodied in one or more hierarchical or non-hierarchical rulebooks. Soft constraints can include spatial constraints that change over time (e.g., lanes that open up as traffic proceeds). A spatial constraint can be a drivable area.

In some embodiments, different constraints are sampled differently. For example, homotopy extractor 503 can operate at 10 Hz and the realization searches to generate trajectories can be performed twice as fast at 20 Hz.

In an embodiment, homotopy extractor 503 generates a set of potential maneuvers for the AV. Instead of hypothesizing objectives and then choosing the objective that results in lower cost, homotopy extractor 503 hypothesizes active constraint sets, referred to as a “homotopy” (defined below), and then chooses the constraint sets that result in lower cost. From route planner 501, homotopy extractor 503 receives a route plan which contains an “anchor path.” The “anchor path” is the best estimate of the lane that the AV is located in, and an optional path (a potentially desired path) which can be used by the AV when performing a lane change. In an embodiment, the route plan also contains speed squared and spatial constraints which are computed along the anchor path (e.g., computed with a bound generator).

Given an initial state of AV 507, a terminal state of AV 507 on the anchor path, a map representation and predictions of other agents in the scene, the homotopy extractor 503 finds all approximately feasible maneuvers the AV can perform. Note that in this context the resulting maneuvers might not be dynamically feasible but the homotopy extractor 503 guarantees that the resulting constraint set describing the maneuver is not an empty set (considering also the AV footprint). An AV maneuver is described by the homotopy, which is a unique space where any path starting with an initial AV state and ending at a terminal AV state can be continuously deformed. To find these maneuvers, the homotopy extractor 503 iterates over all possible decisions the AV can take with respect to other agents, e.g., pass on the left/right side, pass before or after or just stay behind. In short, an output of the homotopy extractor 503 describes the spatio-temporal location of the AV to an agent. Although this can be a computationally expensive search, due to a set of simple checks all infeasible combinations can be eliminated. The homotopy extractor 503 is described in further detail in co-pending application, Attorney Docket No. 46154-0261001, entitled “Homotopic-Based Planner for Autonomous Vehicles,” filed Dec. 7, 2021, which is incorporated by reference herein in its entirety.

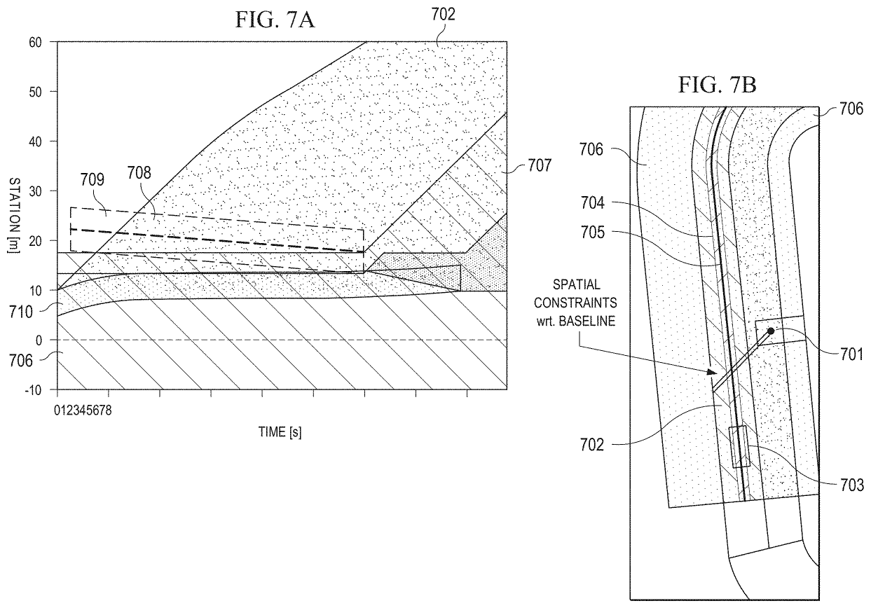

To be able to describe constraints representing where the other agents are located, and what a collision of the AV with these agents mean, every agent is converted into a station-time obstacle or station-spatial-time obstacle, as described in reference to FIGS. 7A and 7B. The station-time constraint is a constraint parameterized over time and the station-spatial-time constraint is a constraint parameterized over both station and time.

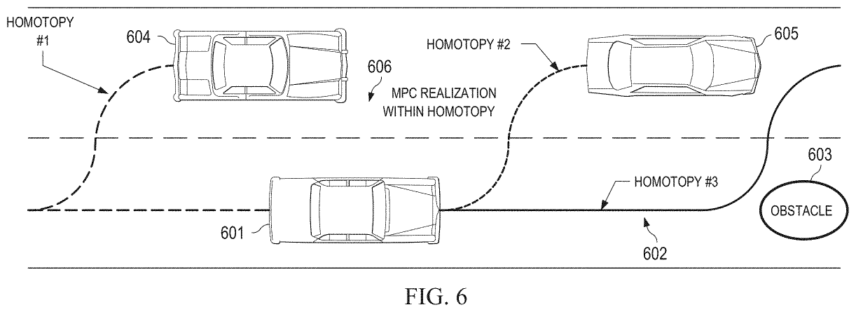

In an embodiment, the realization searches 504a . . . 504n are performed by sample-based maneuver realizer 504 to generate a set of trajectories 1 . . . N for all the extracted homotopies provided by homotopy extractor 503. Sample-based maneuver realizer 504 finds a realization (also referred to herein as a trajectory) that fulfills the constraints imposed by a homotopy and at the same time maximizes passenger comfort. Given a single homotopy, the sample-based maneuver realizer 504 generates dynamically feasible trajectory realization within that homotopy. Sample-based maneuver realizer 504 is described in further detail in reference to FIGS. 6-13. Example techniques for generating maneuvers and/or trajectories are also described in further detail in co-pending application, Attorney Docket No. 46154-0316001, entitled “Vehicle Operation Using Maneuver Generation,” filed Dec. 7, 2021, which is incorporated by reference herein in its entirety.

In an embodiment, trajectory score generator 505 uses one or more rulebooks, one or more machine learning models 509 and/or one or more safety maneuver models 510 to score the trajectories 1 . . . N, and then uses the scores to select the trajectory that is the most compliant with the rules in the one or more rulebooks.

In an embodiment, a predefined cost function is used to generate the trajectory scores. For example, a total order or partial order hierarchical cost function can be used to score the trajectories. The cost function is applied to metrics (e.g., Boolean values) associated with the violation and/or satisfaction of a hierarchy of rules in one or more rulebooks based on priority or relative importance. An example hierarchy of rules based on priority is as follows (from top to bottom): collision avoidance (Boolean), blockage (Boolean), terminal state in desired lane (Boolean), lane change (Boolean) and passenger comfort (double float). In this example, every non-zero priority rule is defined as Boolean to avoid over-optimization of high priority costs. The most important or highest priority rule is to avoid collision, followed by avoiding blockage, followed by avoiding a terminal state in a desired lane, followed by a lane change, followed by comfort rules (e.g., maximum accelerations/decelerations). These example rules are described more fully as follows:
Collision: Is set to TRUE if there exists a state along the scored trajectory where the AV vehicle's footprint collides with the footprint of any other agent (e.g., they are considered to collide if their polygons intersect).
Blockage: A trajectory is considered blocked if the terminal homotopy does not contain the desired goal state and the terminal velocity of the trajectory is below a specified threshold (e.g., 2 m/s).
Terminal State in Desired Lane: Is set to TRUE if the terminal state of a trajectory is found in a lane which is a desired lane change, and is set to TRUE if the footprint of AV 507 crosses a lane divider at any time during the scored trajectory.
Comfort: maximums for acceleration/deceleration, braking distance, longitudinal and lateral clearance can be considered.

For each trajectory, the rules are checked and metrics determined. A cost function is formulated using the metrics and then minimized using, for example, a least squares formulation or any other suitable solver. The trajectory with the lowest cost is the selected trajectory, i.e., the trajectory with the least rule violations or most compliant. Note that the rules described above are merely examples. Those with ordinary skill will recognized that any suitable cost function and rulebook can be used for trajectory scoring, including rulebooks with more or fewer rules.

Tracking controller 506 is used to improve the robustness of system 500 against unexpected spikes in computational demand. Tracking controller 506 is a fast-executing provides steady and smooth control inputs and allows the system 500 to react faster towards disturbances. In an embodiment, tracking controller 506 runs at 40 Hz. The input to tracking controller 506 is the selected trajectory provided by the trajectory score generator 505 that has been parameterized by time, such that tracking controller 506 can query an exact desired position of the AV at a given time.

In an embodiment, the tracking controller 506 is formulated as an MPC-like problem with constraints on the control inputs and states, and with some differences with conventional continuous MPC. However, any suitable multivariable control algorithm can also be used. The MPC-like formulation uses a motion model, a cost function J over a predicted horizon and an optimization algorithm for minimizing the cost function J using a control input u. An example cost function for optimization is a quadratic cost function.

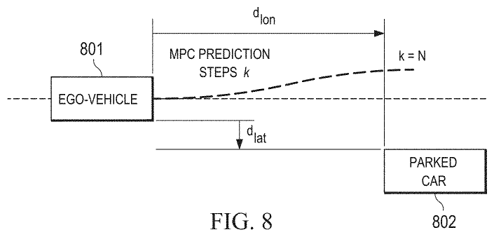

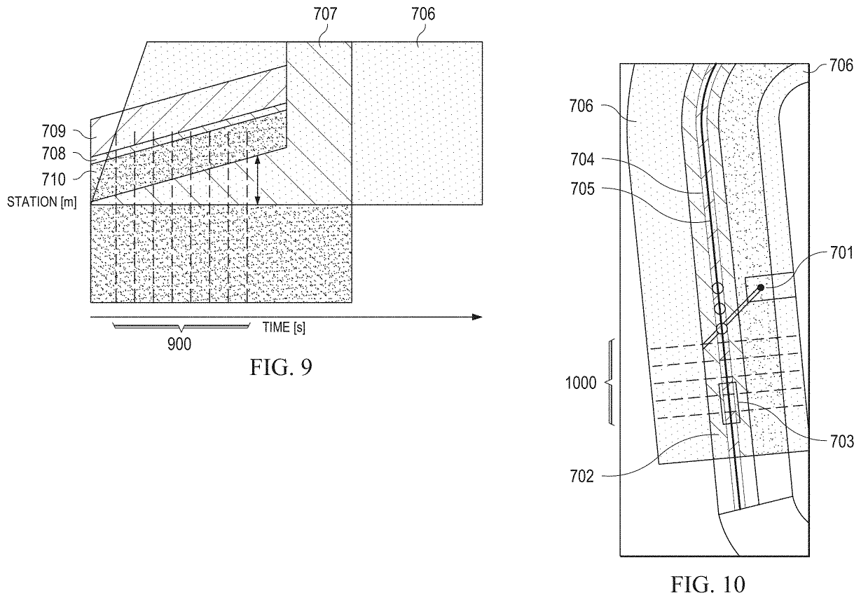

In an embodiment, the dynamic model is a kinematic vehicle model in Cartesian coordinates or any other suitable reference coordinate frame. For example, the kinematic vehicle model can be a bicycle model that allows a side slip angle to be defined geometrically to express yaw rate in terms of variables that are represented with respect to the center of gravity of the AV, as described more fully in reference to FIG. 8. In an embodiment, the cost function J follows a contouring error formulation (orthogonal deviation from the anchor path) where the objective is to minimize the lateral and longitudinal tracking errors. The control input u is not used in this formulation, but is used in a longitudinal speed optimization problem, described in in reference to FIG. 9.

FIG. 6 illustrates three different homotopies and their corresponding realizations, in accordance with one or more embodiments. As previously defined, a homotopy is a unique space where any path starting at an initial AV state and ending at a terminal AV state can be continuously deformed. Given a single homotopy, the sample-based maneuver realizer 504 generates kinematically and/or dynamically feasible trajectories within that homotopy using an MPC-like formulation, as described in reference to FIG. 8.

In this example, vehicle 601 is traveling in right lane 602 and is approaching object 603 which is blocking right lane 602 (e.g., a parked vehicle). Vehicles 604, 605 are traveling in the left lane 606. Vehicle 601 can slow down and merge into to left lane 606 behind vehicle 604 (homotopy #1), accelerate in front of vehicle 604 and merge into left lane 606 behind vehicle 605 (homotopy #2), or accelerate in front of vehicle 605 and merge into left lane 606 in front of vehicle 605 (homotopy #3). These three maneuvers can be generated by homotopy extractor 503 by iterating over all possible decisions vehicle 601 can take with respect to vehicles 604, 605. The output of homotopy extractor 503 describes the spatio-temporal location of vehicle 601 to vehicles 604, 605.

FIG. 7A is an example maneuver description for a pedestrian “jaywalking” scenario illustrated in FIG. 7B, in accordance with one or more embodiments. The vertical axis is station/position (meters) and the horizontal axis is time (seconds). A maneuver description defines a vehicle maneuver exactly and continuously. It is a union of dynamic station-time and station-spatial-time constraints, where the station-spatial-time constraints contain biasing decisions explicitly, and thus also capture proximity constraints. Some examples of station-time constraints are maximal speed and road constraints (e.g., all available lanes). Some examples of station-spatial-time constraints are drivable area and longitudinal and lateral clearance distances from other agents. FIG. 7B is BEV showing example spatial constraints with respect to anchor path 705.

In this example scenario, pedestrian obstacle 701 (a hard or soft obstacle) is “jaywalking” across road 702, and vehicle 703 enters anchor path tube 704 after decelerating with a comfort deceleration. Accordingly, vehicle 703 will need to maneuver to avoid colliding with pedestrian obstacle 701, but must also adhere to station-time and station-spatial-time constraints with respect to anchor path 705, including staying within drivable area 706 and maintaining desired longitudinal and lateral clearance distances from pedestrian obstacle 701, and any other agents in the driving scenario (e.g., other moving or parked vehicles), as described in reference to FIG. 8.

The example maneuver description shown in FIG. 7A describes the maneuver space that can be used by vehicle 703 to avoid colliding with pedestrian obstacle 701. In this example, the maneuver space 707 is a disjoint space that is limited by clearance region 709 of pedestrian obstacle 701 and drivable area 706. Note that in FIG. 7A, region 708 represents a hard pedestrian obstacle and region 709 represents a soft pedestrian obstacle. Thus, region 708 indicates (in station and time) when pedestrian obstacle 701 will definitely collide with pedestrian obstacle 701 if no avoidance maneuver is performed in accordance with the maneuver description. Region 710 represents the avoidance maneuver into the adjacent lane.

Imposing station-time and station-spatial-time constraints on top of each other results in a full maneuver description that can be continuously sampled along its defined time horizon, which greatly streamlines the architecture of planning system 500. There is no need for further decisions, and proximity constraints are directly represented as a continuous function which can be used for optimization.

FIG. 8 illustrates an example formulation for an example avoidance maneuver performed by vehicle 801 to avoid parked car 802 in the travel lane of vehicle 801, in accordance with one or more embodiments. In particular, proximity constraints are illustrated for both the lateral and longitudinal displacements individually, where a longitudinal deviation dim, is defined as the distance between vehicle 801 and parked car 802, and a lateral deviation that is defined as the lateral distance between vehicle 801 and parked car 802. The N MPC-like prediction steps k are shown constrained to be within dim and that.

In an embodiment, given a motion model, station-time and station-spatial-time constraints and cost function, a trajectory optimization problem is solved by tracking controller 506. In an embodiment, the trajectory optimization problem is solved according to Equation [1] below, by formulating the proximity constraints in the same manner as a conventional MPC formulation:

$${x}_{1 : N}^{*} , {u}_{1 : N - 1}^{*} {λ}_{1 : N}^{*} = {arg min}_{{x}_{1 : N} {u}_{1 : N - 1} {λ}_{{1 : N}_{s . t .}}} {\sum }_{k = 0}^{N - 1} {J}_{stage} ( {x}_{k} , {u}_{k} , {λ}_{k} ) + {J}_{terminal} ( {x}_{N} , {λ}_{N} ) , \\ {x}_{k + 1} = f ( {x}_{k} , {u}_{k} ) , \\ {c}_{k} ( {x}_{k} , {λ}_{k} ) \leq 0 , \\ x ∈ X , \\ u ∈ U , \\ λ ∈ ⩓ . \qquad [ 1 ]$$

In an embodiment, the optimization problem can be formulated in state space defined in a curvilinear coordinate frame, where the states are defined with respect to a center of gravity (CoG) of the vehicle. Six slack variables are introduced as additional inputs to all for soft constraints. In this example embodiment, tracking controller 506 takes as input the selected trajectory output by trajectory score generator 505 parameterized in time. This means that tracking controller 506 can query the exact desired position of the ∀V, xᵢ=[s, n, μ, v, a, δ, \dot{δ}] at any time tᵢ, where s progress, n is lateral error, μ is local heading (μ=ψ(yaw)−φₛ(pitch)), v is velocity, a is acceleration in the projected driving direction, δ is the steering angle, \dot{δ} is the steering rate, u is a vector of input variables including jerk and steering rate,

$$u = [ \begin{matrix}{u}_{jerk} \\ {u}_{δ}^{¨}\end{matrix} ] , {λ}_{hard} = [ \begin{matrix}{λ}_{n} \\ {λ}_{a} \\ {λ}_{s}\end{matrix} ] and {λ}_{soft} = [ \begin{matrix}{λ}_{n , soft} \\ {λ}_{v , soft} \\ {λ}_{a , soft}\end{matrix} ]$$

are slack variables, where λₙ is slack on the lateral tube, λₐ is the slack on acceleration, λₛ is the slack on progress, λ_{n,soft} is slack on the soft lateral tube, λ_{v,soft} is slack on soft velocity, λ_{a,soft} is slack on soft acceleration, and J_{stage}( ) and Jₜₑᵣₘᵢₙₐₗ( ) are cost functions. Equation [1] can be solved using any suitable solver. Other embodiments can use different trajectory optimization methods, including but not limited to learning-based methods or methods that use control barrier functions.

In an embodiment, the motion model is a kinematic bicycle model that allows the side slip angle β to be defined geometrically, so that the velocity (vₓ, v_{y}) and yaw rate \dot{ψ} of the vehicle can be expressed in terms of β, as shown in Equation [2]:

$$\dot{x} = [ \begin{matrix}\dot{s} \\ \dot{n} \\ \dot{μ} \\ \dot{v} \\ \dot{a} \\ \dot{δ} \\ \ddot{δ}\end{matrix} ] = [ \begin{matrix}\frac{v cos ( μ + β )}{1 - n κ} \\ v sin ( μ + β ) \\ \frac{v}{{l}_{r}} sin ( β ) - κ \frac{v cos ( μ + β )}{1 - n κ} \\ a \\ {u}_{jerk} \\ \dot{δ} \\ {u}_{δ}^{¨}\end{matrix} ] , \qquad [ 2 ]$$

where

$$β = arctan ( \frac{{l}_{r}}{{l}_{r} + {l}_{f}} tan ( {δ}_{real} ) ) , and \qquad [ 3 ]$$

where lᵣ is the length from the front of the AV to the CoG of the vehicle and l_{f} is the length from the rear of the vehicle to the CoG of the vehicle.

In an embodiment, the cost functions J_{stage} and Jₜₑᵣₘᵢₙₐₗ are given by:

J_{stage}=J_{comfort}(xₖ,uₖ)+J_{tracking}(xₖ)+J_{slack}(sₖ)∀k∈{0, . . . ,N−1}, [4]

and

Jₜₑᵣₘᵢₙₐₗ=J_{tracking}(x_{N})+J_{slack}(S_{N}). [5]

In an embodiment, tracking performance is only required for the first three states, the comfort requirement is applicable to acceleration and both inputs. Both the tracking and comfort objectives are implemented as a quadratic cost. Slack violation is penalized by either a quadratic or a linear cost:

$$\begin{matrix}{J}_{tracking} = {( x - {x}_{ref} )}^{T} Q ( x - {x}_{ref} ) , & [ 6 ] \\ {J}_{comfort} = [ {a}_{lon} {a}_{lat} {u}^{T} ] R [ \begin{matrix}{a}_{lon} \\ {a}_{lat} \\ u\end{matrix} ] , & [ 7 ] \\ {J}_{slack} = {s}^{T} E {s}_{soft} + \overline{H} {s}_{hard} , & [ 8 ]\end{matrix}$$

where Q=diag(qₛ,qₙ,q_{μ}, 0,0,0,0), R=diag(rₐₗₒₙ,rₐₗₐₜ,rⱼₑᵣₖ,r_{\dot{δ}}), H̅=[eₛ_{ₙ}, eₛ_{ₐ}, eₛ_{ₛ}] and E=diag(s_{nsoft},s_{vsoft},s_{asoft}), represents the individual weight factors of each cost term.

Note that the formulation of Equations [1]-[8] differs from conventional MPC because MPC uses a dynamic lookahead to approximate the biasing decision and sample the spatial constraints with the predicted time from MPC. The above MPC-like formulation, however, re encodes the constraints in the maneuver description (the homotopy), and hence no additional decisions or approximations have to be made by tracking controller 506.

In an embodiment, a rulebook defines high-level constraints that provide behavioral expectations of a vehicle. A course motion plan is received from a planning module (e.g., planning module 404), to which a more refined realization is generated that considers the motion model and cost function described above. One or more rules in the rulebook are considered in the MPC-like optimization described above. The one or more rules specify the solution space for the trajectory optimization, defined by the course motion plan provided by the planning module 404. In some embodiments, one or more rules can be re-evaluated within the MPC formulation, such a proximity rule. Table I below is an example of adopted rules.

TABLE I
Example Rulebook Constraints

| Rule Implemented By | |
|---|---|
| Planning Module | MPC Implementation Detail |
| Safety (collision avoidance) | Proximity rule as a non-linear |
| | inequality constraint on both |
| | velocity and lateral position |
| Stay in lane | Non-linear constraint on deviation |
| | from the path with correction for the |
| | vehicle footprint w.r.t. the true lane |
| | boundaries |
| Max, Min speed limit, stop sign | State constraint on velocity |
| Comfortable accel/decel | State constraint on acceleration |
| No sudden braking | State constraint on jerk |

### Linear Inequality Constraints

The above-specified example rulebook constraints are converted into state constraints. The feasible set of states, x∈X, inputs u∈U, and slack variables, s∈S, are expressed by linear inequality constraints. Note that the slack variables are by definition semipositive. The linear inequality constraints are hard and do not allow for slack, and thus cannot control the violation of the constraints. In an embodiment, the vehicle does not operate close to the boundaries of the state constraints:

xₘᵢₙ≤x≤xₘₐₓ,

uₘᵢₙ≤u≤uₘₐₓ,

0≤a≤aₘₐₓ. [9]

### Non-Linear Inequality Constraints

Through the use of general inequality constraints, more complex constraints can be imposed. These more complex constraints can be non-linear combinations of different states, inputs and online-specifiable variables. Generally, constraints are used on lateral position and speed to generate a tube around the anchor path given by the planning module 404. Slack variables are used in these constraint formulations to explicitly control and penalty violations. In an embodiment, the following non-linear inequality constraints are defined:

c^{station}(x,λₛ)≤0,

c^{vel}(x,λ_{vsoft})≤0

c^{tube_hard}(x,λₙ)≤0,

c^{tube_soft}(x,λ_{nsoft})≤0,

c^{a_hard}(x,λₐ)≤0,

c^{a_soft}(x,λ_{asoft})≤0,

c^{vel_prox}(x,λᵥ)≤0.

FIG. 9 illustrates sampling station-time constraints, in accordance with one or more embodiments. Due to the fact that the station-time constraints are not continuously differentiable, the station-time constraints need to be discretized through sampling, as indicated by vertical lines 900, where each vertical line represents a sample at a particular time and thus discretizes the station-time constraints. Since the station-time constraints are already parametrized only in time, the corresponding MPC timesteps can be used. Note that sampling station-time constraints does not result in any approximation.

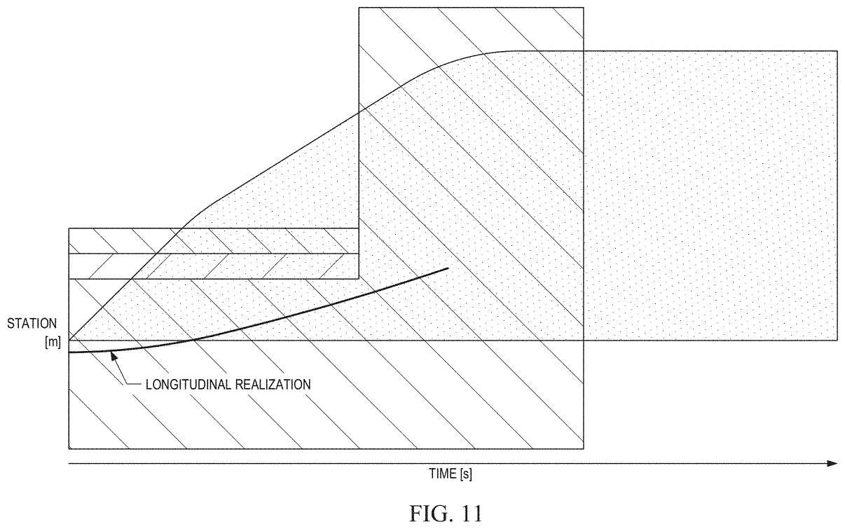

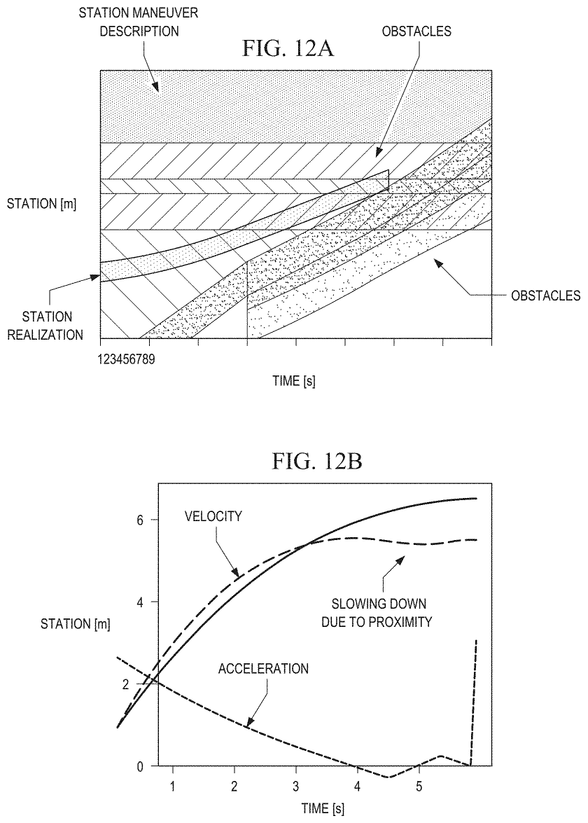

FIG. 10 illustrates sampling spatial-station-time constraints, in accordance with one or more embodiments. Sampling spatial-station-time constraints is more complicated than sampling station-time constraints that are parameterized only in time because spatial-station-time constraints are parameterized in time and station. The station component has to be sampled a priori to construct the optimization problem. As described in reference to FIG. 11, the solution to a longitudinal speed optimization problem can be used as an initial guess for the optimization.

FIG. 11 illustrates an example longitudinal realization, in accordance with one or more embodiments. In an embodiment, the optimization problem described above is initialized with the result of another optimization using the MPC-like formulation described in reference to FIG. 8, which is faster to solve then the above optimization. In the initialization optimization problem, a point mass longitudinal problem (speed optimization) is solved with a double integrator with acceleration as the controllable input u. The initialize optimization includes station speed profile constraints and homotopy station-time constraints. This allows imposing acceleration constraints in the optimization as well. For example, since the speed profile constraints also consider the curvature of the path of the AV 507, the longitudinal initial guess will also indirectly limit the maximal lateral acceleration. Therefore, in addition to the stations used for sampling the spatial constraints, the initialization optimization also provides an initial guess of velocity and acceleration of AV 507 for the optimization.

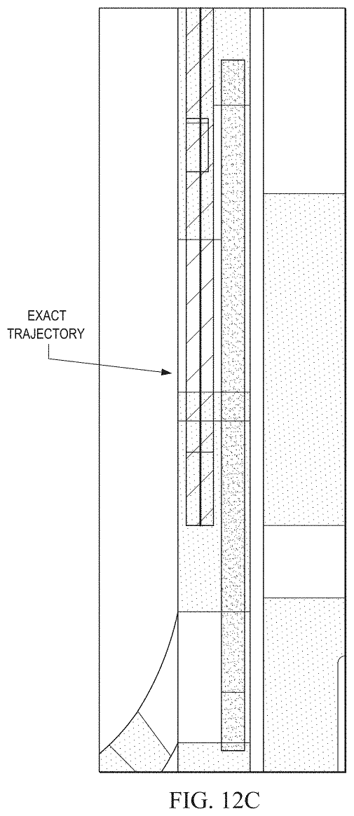

FIGS. 12A-12C illustrate the results of an optimization of a homotopy with two agents, in accordance with one or more embodiments. In FIG. 12A, the motion prediction 1201 of the vehicle is shown as fully within the station constraints and thus, it is able to accelerate fast enough such that merging into the adjacent lane 1202 is feasible. This can also be seen in FIG. 12B, where the acceleration of the vehicle is very high at the start of the prediction horizon, and slowly decreases as the velocity of the vehicle is increasing. In FIG. 12B, as the vehicle is getting closer to a parked car ahead of the vehicle, the velocity decreases due to the proximity constraints. Finally, FIG. 12C depicts the entire predicted trajectory 1203 of vehicle 1200, including predictions of the other two agents 1204a and 1204b (e.g., other vehicles).

At this point the large optimization problem is simple to solve since it consists only of station constraints, spatial constraints, the motion model and the comfort objectives. Due to the spatial constraints sampling, the optimization problem is solved iteratively by using the results from the previous iteration to resample the spatial constraints. In an embodiment, the optimization problem is considered converged if the optimized trajectory satisfies all original constraints (without sampling). In a well posed problem, convergence can occur in a single iteration.

### Example Processes

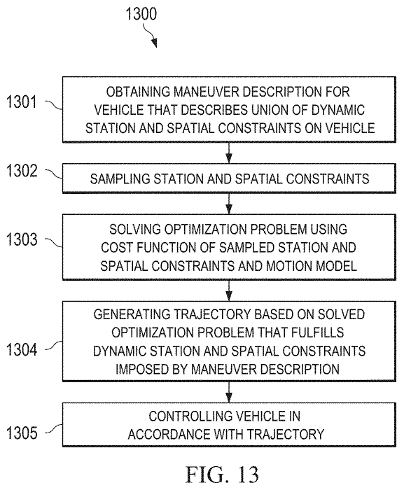

FIG. 13 is a flow diagram of a process for rule-based trajectory evaluation, in accordance with one or more embodiments. Process 1300 can be implemented using, for example, computer system 300, as described in reference to FIG. 3.

Process 1300 can begin by obtaining a maneuver description for a vehicle (1301). The maneuver description describes a union of dynamic station-time constraints and station-spatial-time constraints on the vehicle. The dynamic station-time constraints are parameterized in time and the dynamic station-spatial-time constraints are parameterized in station and time.

Process 1300 continues by sampling the dynamic station-time constraints and dynamic station-spatial-time constraints (1302), as described in reference to FIGS. 5-8.

Process 1300 continues by solving an optimization problem using a cost function of the sampled dynamic station-time constraints, the sampled dynamic station-spatial-time constraints and a motion model (1303), as described in reference to FIGS. 5-8.

Process 1300 continues by generating a trajectory based on the solved optimization problem, wherein the trajectory fulfills the dynamic station-time constraints and the dynamic station-spatial-time constraints imposed by the maneuver description (1304), as described in reference to FIGS. 5-8.

Process 1300 continues by controlling the vehicle in accordance with the trajectory (1305).

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further including,” in the foregoing description or following claims, what follows this phrase can be an additional step or entity, or a sub-step/sub-entity of a previously-recited step or entity.

### Additional Examples

Example implementations of the features described herein are provided below.

Example 1: A method includes: obtaining, using at least one processor, a maneuver description for a vehicle, the maneuver description describing a union of dynamic station-time constraints and station-spatial-time constraints on the vehicle, where the dynamic station-time constraints are parameterized in time and the dynamic station-spatial-time constraints are parameterized in station and time; sampling, using the at least one processor, the dynamic station-time constraints and dynamic station-spatial-time constraints; solving, using the at least one processor, an optimization problem using a cost function of the sampled dynamic station-time constraints, the sampled dynamic station-spatial-time constraints and a motion model; and generating, using the at least one processor, a trajectory based on the solved optimization problem, where the trajectory fulfills the dynamic station-time constraints and the dynamic station-spatial-time constraints imposed by the maneuver description.

Example 2: The method of Example 1, where the dynamic station-spatial-time constraints contain biasing decisions explicitly.

Example 3: The method of any one of the preceding Examples, where the motion model is a kinematic bicycle model.

Example 4: The method of any one of the preceding Examples, where the solving is continuous and iterative.

Example 5: The method of any one of the preceding Examples, where the continuous and iterative solving converges when the optimized trajectory satisfies the dynamic station-time and station-spatial-time constraints without sampling.

Example 6: The method of any one of the preceding Examples, where the trajectory maximizes comfort constraints imposed on the vehicle.

Example 7: The method of any one of the preceding Examples, the method further including: solving, using the at least one processor, a longitudinal speed optimization problem to determine where to start sampling the dynamic station-time and dynamic station-spatial-time constraints.

Example 8: The method of any one of the preceding Examples, where the longitudinal speed optimization problem includes static speed profile constraints and maneuver station-time constraints.

Example 9: The method of any one of the preceding Examples, where the static speed profile constraints limit maximal lateral acceleration of the vehicle by considering path curvature.

Example 10: The method of any one of the preceding Examples, where the solving the longitudinal speed opination problem provides an initial guess of acceleration and velocity for solving the optimization problem.

Example 11: The method of any one of the preceding Examples, where the method also includes initiating, using a control circuit, a maneuver by the vehicle based on the trajectory.

Example 12: A non-transitory, computer-readable storage medium having stored thereon instructions, that when executed by at least one processor, causes the at least one processor to perform the method of any one of Examples 1-11.

Example 13: A vehicle including: at least one processor; a non-transitory, computer-readable storage medium having stored thereon instructions, that when executed by the at least one processor, causes the at least one processor to perform the method of any one of Examples 1-11.

1. A method comprising:
obtaining, using at least one processor, a maneuver description for a vehicle, the maneuver description describing a union of dynamic station-time constraints and station-spatial-time constraints on the vehicle, wherein the dynamic station-time constraints are parameterized in time and the dynamic station-spatial-time constraints are parameterized in station and time;
sampling, using the at least one processor, the dynamic station-time constraints and dynamic station-spatial-time constraints;
solving, using the at least one processor, an optimization problem using a cost function of the sampled dynamic station-time constraints, the sampled dynamic station-spatial-time constraints and a motion model; and
generating, using the at least one processor, a trajectory based on the solved optimization problem, wherein the trajectory fulfills the dynamic station-time constraints and the dynamic station-spatial-time constraints imposed by the maneuver description.

2. The method of claim 1, wherein the dynamic station-spatial-time constraints contain biasing decisions explicitly.

3. The method of claim 1, wherein the motion model is a kinematic bicycle model.

4. The method of claim 1, wherein the solving is continuous and iterative.

5. The method of claim 4, wherein the continuous and iterative solving converges when the optimized trajectory satisfies the dynamic station-time and station-spatial-time constraints without sampling.

6. The method of claim 1, wherein the trajectory maximizes comfort constraints imposed on the vehicle.

7. The method of claim 1, further comprising:
solving, using the at least one processor, a longitudinal speed optimization problem to determine where to start sampling the dynamic station-time and dynamic station-spatial-time constraints.

8. The method of claim 7, wherein the longitudinal speed optimization problem includes static speed profile constraints and maneuver station-time constraints.

9. The method of claim 8, wherein the static speed profile constraints limit maximal lateral acceleration of the vehicle by considering path curvature.

10. The method of claim 7, wherein the solving the longitudinal speed optimization problem provides an initial guess of acceleration and velocity for solving the optimization problem.

11. The method of claim 1, further comprising:
initiating, using a control circuit, a maneuver by the vehicle based on the trajectory.

12. A non-transitory, computer-readable storage medium having stored thereon instructions, that when executed by at least one processor, causes the at least one processor to perform operations comprising:
obtaining a maneuver description for a vehicle, the maneuver description describing a union of dynamic station-time constraints and station-spatial-time constraints on the vehicle, wherein the dynamic station-time constraints are parameterized in time and the dynamic station-spatial-time constraints are parameterized in station and time;
sampling the dynamic station-time constraints and dynamic station-spatial-time constraints;
solving an optimization problem using a cost function of the sampled dynamic station-time constraints, the sampled dynamic station-spatial-time constraints and a motion model; and
generating trajectory based on the solved optimization problem, wherein the trajectory fulfills the dynamic station-time constraints and the dynamic station-spatial-time constraints imposed by the maneuver description.

13. A vehicle comprising:
at least one processor;
a non-transitory, computer-readable storage medium having stored thereon instructions, that when executed by the at least one processor, causes the at least one processor to perform operations comprising:
obtaining a maneuver description for a vehicle, the maneuver description describing a union of dynamic station-time constraints and station-spatial-time constraints on the vehicle, wherein the dynamic station-time constraints are parameterized in time and the dynamic station-spatial-time constraints are parameterized in station and time;
sampling the dynamic station-time constraints and dynamic station-spatial-time constraints;
solving an optimization problem using a cost function of the sampled dynamic station-time constraints, the sampled dynamic station-spatial-time constraints and a motion model; and
generating trajectory based on the solved optimization problem, wherein the trajectory fulfills the dynamic station-time constraints and the dynamic station-spatial-time constraints imposed by the maneuver description.

14. The non-transitory, computer-readable storage medium of claim 12, wherein the dynamic station-spatial-time constraints contain biasing decisions explicitly.

15. The non-transitory, computer-readable storage medium of claim 12, wherein the motion model is a kinematic bicycle model.

16. The non-transitory, computer-readable storage medium of claim 12, wherein the solving is continuous and iterative.

17. The non-transitory, computer-readable storage medium of claim 16, wherein the continuous and iterative solving converges when the optimized trajectory satisfies the dynamic station-time and station-spatial-time constraints without sampling.

18. The non-transitory, computer-readable storage medium of claim 12, wherein the trajectory maximizes comfort constraints imposed on the vehicle.

19. The non-transitory, computer-readable storage medium of claim 12, the operations further comprising:
solving a longitudinal speed optimization problem to determine where to start sampling the dynamic station-time and dynamic station-spatial-time constraints.

20. The non-transitory, computer-readable storage medium of claim 19, wherein the longitudinal speed optimization problem includes static speed profile constraints and maneuver station-time constraints.
